(19) United States
(12) Patent Application Publication
(10) Pub. No.: US 2012/0181312 A1
(43) Pub. Date: Jul. 19, 2012

(54) Handy Towel

(76) Inventor: Albert Dozier, Huntsville, AL (US)

(21) Appl. No.: 13/112,363

(22) Filed: May 20, 2011

Related U.S. Application Data
(60) Provisional application No. 61/433,360, filed on Jan. 17, 2011.

(51) Int. Cl. A45F 5/00; B23P 11/00

(52) U.S. Cl. 224/269; 29/428

(57) ABSTRACT

A towel assembly for attaching to an article of clothing comprising: a belt clip, where said belt clip includes an outer surface and an inner surface; a Velcro square on the outer surface of the belt clip; and a towel, where the towel includes a reciprocal Velcro square that adjoins to the Velcro square on the outer surface of the belt clip. In one particular embodiment, the clip includes two adjoining clip portions. The present invention further includes a method of suspending a towel on a belt comprising the steps of: attaching a Velcro square to an outer surface of a belt clip; attaching a reciprocal Velcro square on a towel; placing the belt clip onto to a belt of a user; and joining the towel to the belt clip by using the respective Velcro squares.

### CROSS REFERENCE TO OTHER APPLICATIONS

This application claims priority to U.S. Provisional Application Ser. No. 61/433,360 filed on Jan. 17, 2011.

### BACKGROUND OF THE INVENTION

1. Field of Invention

The present invention relates to a towel attachment assembly that allows a user to secure a towel on a article of clothing such as a belt so it is readily accessible at all times.

2. Description of Related Art

Golfers, bowlers and other sports frequently require the participants to use a towel to wipe their hands or equipment prior to continuing play. Many times golfers attach a towel to their bag so that the golfer may wipe down the face of their golf club prior to or immediately after striking their ball. On occasion a golfer's cart and bag are not readily accessible therefore the golfer may not have the towel available to wipe their club prior to striking the ball. Also some golfers wipe their ball on the green prior to putting and the cart may not be driven upon the greens of most golf courses.

In other applications such as bowlers or other athletes who may handle equipment the use of a towel is necessary to wipe the hands, ball, bat handle or club that may be handled by the athlete. Use of a readily accessible towel may also be convenient for some workers such as bartenders, mechanics or construction workers. Obviously a need exists to maintain a towel in a convenient position and readily accessible by the user in many circumstances.

### SUMMARY OF THE INVENTION

The present invention relates to a towel assembly for attaching to an article of clothing comprising: a belt clip, where said belt clip includes an outer surface and an inner surface; a Velcro square on the outer surface of the belt clip; and a towel, where the towel includes a reciprocal Velcro square that adjoins to the Velcro square on the outer surface of the belt clip. In one particular embodiment, the clip includes two adjoining clip portions. The present invention further includes a method of suspending a towel on a belt comprising the steps of: attaching a Velcro square to an outer surface of a belt clip; attaching a reciprocal Velcro square on a towel; placing the belt clip onto to a belt of a user; and joining the towel to the belt clip by using the respective Velcro squares.

### BRIEF DESCRIPTION OF DRAWINGS

FIG. 1 depicts a Velcro square as contemplated by the present invention.

FIG. 2 depicts a belt clip with a Velcro square attached one side thereof in accordance with the present invention.

FIG. 3 depicts a towel with a Velcro square attachment in accordance with the present invention.

### DETAILED DESCRIPTION

The present invention relates to a hand towel assembly system where a belt clip is provided with a Velcro square that provides a means to adjoin a towel thereto. As contemplated by the present invention, Velcro is used upon an outer side of the belt clip, which may be attached to a belt of a user. The Velcro square is provided for the attachment of a reciprocal Velcro square that is placed upon a towel. The hand towel assembly provides a means to attach a towel to a user's belt so that it is readily accessible as needed by the user thereof.

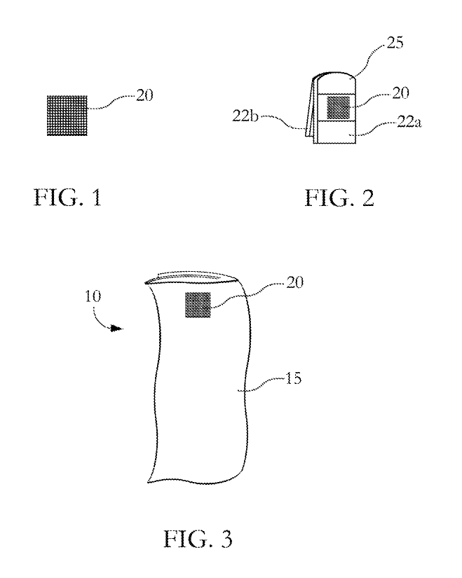

The FIG. 1 depicts a Velcro square 20 in accordance with the present invention. The Velcro Square 20 is applied to the belt clip and a reciprocal Velcro square is applied to the towel in order to effectively secure the towel onto the belt clip. A Belt Clip 25 as depicted in the FIG. 2 includes two adjoining clip portions 22a, 22b where an outer portion 22a includes the Velcro Square 20. The Velcro Square 20 on the Belt Clip 25 may be used to attach a towel, which includes a Velcro square. An exemplary Towel 10 is depicted in FIG. 3. The Towel 10 includes a Velcro Square 20 and a Body Portion 15. When the Towel 10 is used in conjunction with the Clip 25, the complete towel assembly is attached to the belt of a user where the Towel 10 is attached to the Clip 25.

The complete assembly towel assembly according to the present invention therefore provides a means for the user to conveniently attach and maintain a towel that is readily accessible during use thereof. The attachment of the Velcro squares to the belt clip and onto the towel creates an attachment means necessary to secure the towel in place. With a multi-purpose towel as contemplated by the present invention, a user thereof may use the towel while it remains worn on the belt of the user or briefly detached for use. Because the clip includes the Velcro square it may also be used to attach golf gloves or other items that may have a reciprocal Velcro attachment means in order to attach it to the belt clip in accordance with the present invention.

The hand towel assembly according to the present invention is capable of securing the towel on an article of clothing such as the belt and is designed for athletes, golfers, bowlers, mechanics, bartenders or other individuals who may need a towel readily accessible. Furthermore since the towel is clipped on the belt, the likelihood of the towel being lost during use is diminished significantly. The instant invention has been shown and described in what it considers to be the most practical and preferred embodiments. It is recognized, however, that departures may be made there from within the scope of the invention and that obvious modifications will occur to a person skilled in the art.

What is claimed is:

1. A towel assembly for attaching to an article of clothing comprising:
a. a belt clip, where said belt clip includes an outer surface and an inner surface;
b. a Velcro square on the outer surface of the belt clip; and
c. a towel, where the towel includes a reciprocal Velcro square that adjoins to the Velcro square on the outer surface of the belt clip.

2. The towel assembly according to claim 1, where the clip includes two adjoining clip portions.

3. A method of suspending a towel on a belt comprising the steps of:
a. attaching a Velcro square to an outer surface of a belt clip;
b. attaching a reciprocal Velcro square on a towel;
c. placing the belt clip onto to a belt of a user; and
d. joining the towel to the belt clip by using the respective Velcro squares.

4. The method according to claim 3, where said step of attaching the reciprocal Velcro square includes either gluing or stitching the square to the towel.

5. The method according to claim 3, where the belt clip includes two adjoining clip portions.
